(19) United States
(12) Patent Application Publication
(10) Pub. No.: US 2016/0239110 A1
(43) Pub. Date: Aug. 18, 2016

(54) METHOD FOR AUTOMATICALLY TRANSFERRING CONTROL RIGHT OF MOUSE BETWEEN PERSONAL COMPUTER AND HANDHELD COMPUTER

(71) Applicants: Johnny Chen, Taipei City (TW); Hou-Hao Hsun, Taipei city (TW)

(72) Inventors: Johnny Chen, Taipei City (TW); Hou-Hao Hsun, Taipei city (TW)

(73) Assignee: I/O INTERCONNECT INC., Taipei City (TW)

(21) Appl. No.: 14/622,744

(22) Filed: Feb. 13, 2015

(51) Int. Cl. G06F 3/0354

(52) U.S. Cl. CPC G06F 3/03543

(57) ABSTRACT

The method includes the steps of: a) displaying a cursor of the mouse on a screen of the personal computer; b) operatably connecting the handheld computer to the personal computer; c) creating an edge bar on an edge of a screen of the handheld computer; d) the handheld computer monitoring an event of the personal computer; e) transferring the control right of the mouse from the personal computer to the handheld computer and transferring the cursor from the screen of the personal computer to the screen of the handheld computer when the cursor exceeds an edge of the screen of the personal computer; and f) transferring the control right of the mouse from the handheld computer to the personal computer and transferring the cursor from the screen of the handheld computer to the screen of the personal computer when the cursor touches the edge bar of the screen of the handheld computer.

### BACKGROUND OF THE INVENTION

1. Technical Field

The invention relates to combination of a personal computer and a handheld computer, particularly to cursor control between a personal computer and a handheld computer.

2. Related Art

Handheld computers, such as smartphones and tablets, have become an essential for most modern people. Many users of handheld computers like to connect their handheld computers to a personal computer (for example, a desktop or laptop computer) to serve as a second computer. Usually, a personal computer must be equipped with a mouse and a keyboard as input devices. Although most handheld computers are provided with a touchscreen, a mouse and keyboard are still much more convenient then a touchscreen in operation. When a user wants to use a mouse of a personal computer to operate his or her handheld computer connected to the personal computer, the user must proceed with a series of manual operations to transfer a control right of the mouse to the handheld computer so as to transfer a cursor of the mouse to the handheld computer. When the user wants to transfer the cursor from the handheld computer back to the personal computer, he or she must proceed a series of manual operations again. In other words, the cursor and the control right of the mouse cannot be automatically transferred between the handheld computer and the personal computer. The user cannot directly and automatically transfer the cursor of the mouse between the personal computer and the handheld computer without such a series of manual operations. This is not very easy for general users. However, there is no solution in the market yet.

### SUMMARY OF THE INVENTION

An object of the invention is to provide a method for automatically transferring control right of mouse between personal computer and handheld computer, which can automatically transfer a control right and a cursor of a mouse between a personal computer and a handheld computer without any manual operation.

To accomplish the above object, the method of the invention includes the steps of: a) displaying a cursor of the mouse on a screen of the personal computer; b) operatably connecting the handheld computer to the personal computer; c) creating an edge bar on an edge of a screen of the handheld computer; d) the handheld computer monitoring an event of the personal computer; e) transferring the control right of the mouse from the personal computer to the handheld computer and transferring the cursor from the screen of the personal computer to the screen of the handheld computer when the cursor exceeds an edge of the screen of the personal computer; and f) transferring the control right of the mouse from the handheld computer to the personal computer and transferring the cursor from the screen of the handheld computer to the screen of the personal computer when the cursor touches the edge bar of the screen of the handheld computer.

### BRIEF DESCRIPTION OF THE DRAWINGS

FIG. 1 is a schematic view of connection of a handheld computer and a personal computer;

FIG. 2 is a flowchart of the invention;

FIGS. 3 and 4 are schematic views showing transfer of the cursor between the handheld computer and the personal computer according to the invention; and

FIG. 5 is a flowchart of a second embodiment of the invention.

### DETAILED DESCRIPTION OF THE INVENTION

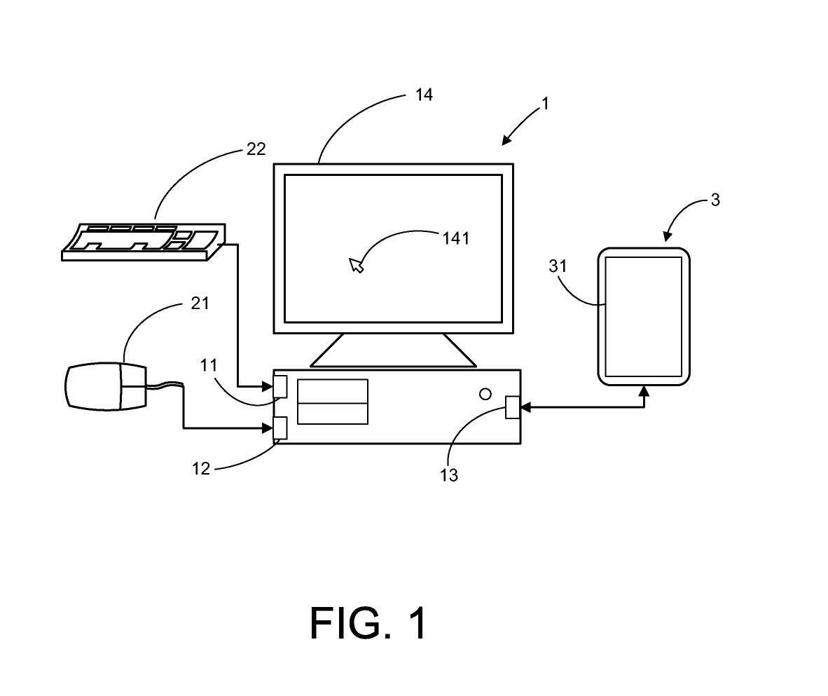

Please refer to FIG. 1. A personal computer 1, which may be a desktop computer or a laptop computer, is equipped with a mouse 21, a keyboard 22 and a monitor 14. The mouse 21 and keyboard 22 are separately connected to the personal computer 1 through two USB (universal serial bus) ports 11, 12. A handheld computer 3, such as a smartphone or a tablet computer, is connected to the personal computer 1 through another USB port 13. Of course, the handheld computer 3 has a touchscreen 31. When the invention is adopted, the mouse 21 can be automatically transferred to either operate the personal computer 1 or the handheld computer 3 without any manual operation. In other words, the control right of the mouse 21 will be automatically transferred between the personal computer 1 and the handheld computer 3.

The method of the invention is performed by a software application installed in the handheld computer 3. So far, the software application only applies to the handheld computer 3 with the ANDROID operating system. However, it will be possible that the invention can be applied to handheld computers with operating systems other than ANDROID in the future.

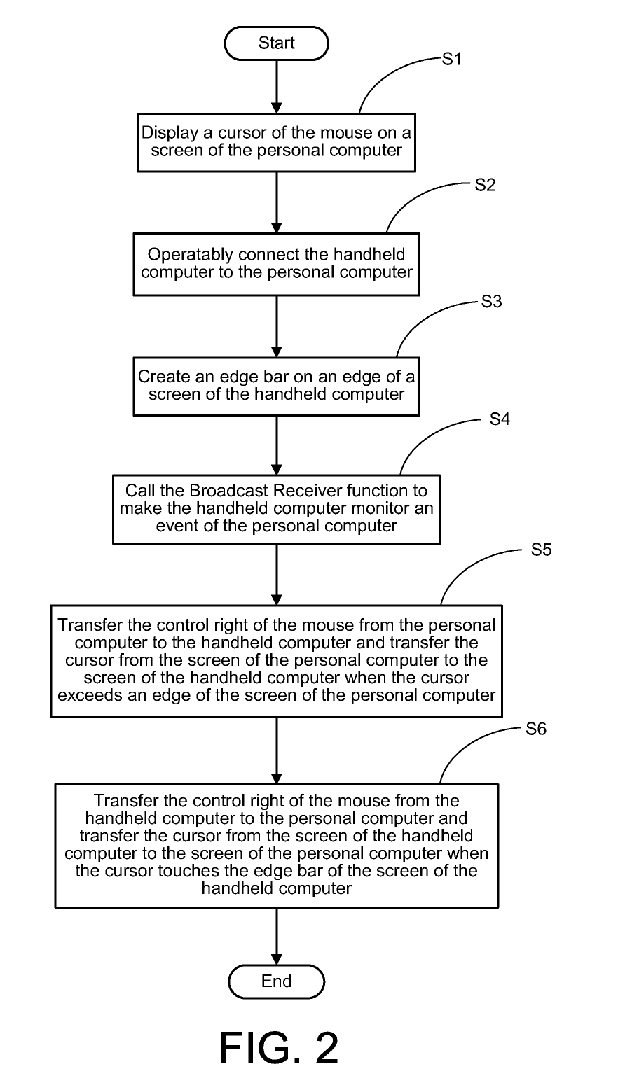

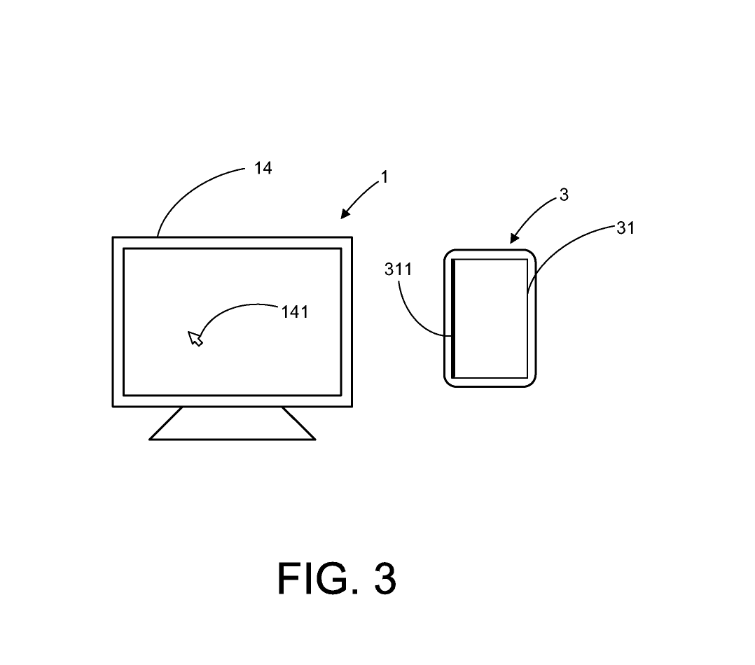

Please refer to FIG. 2, which shows a flowchart of the invention. First, in step S1, a cursor 141 of the mouse 21 is displayed on a screen of the monitor 14 of the personal computer 1 as shown in FIG. 1. In step S2. the handheld computer 3 is operatably connected to the personal computer 1 as shown in FIG. 1. Such a connection may be implemented by USB. In step S3, an edge bar 311 is created on an edge of a screen of the touchscreen 31 of the handheld computer 3. The step S3 is implemented by the “WindowManager.LayoutParams” function of the ANDROID Software Development Kit (SDK). The edge bar 311 may be visible or invisible and may be located at the right, left, top or bottom edge of the touchscreen 31. Usually, left and right edges are preferred because they correspond with operational instinct under a normal arrangement of the handheld computer 3 being on the left or right side of the personal computer 1. For example, FIG. 3 shows the edge bar 311 on the left edge of the screen of the handheld computer 3 which is located on the right side of the personal computer 1. The edge bar 311 is a bold line created by the software application and shown on the screen but not a tangible matter. Preferably, the length of the edge bar 311 is equal to that of the side of the touchscreen 31 on which the edge bar 311 resides.

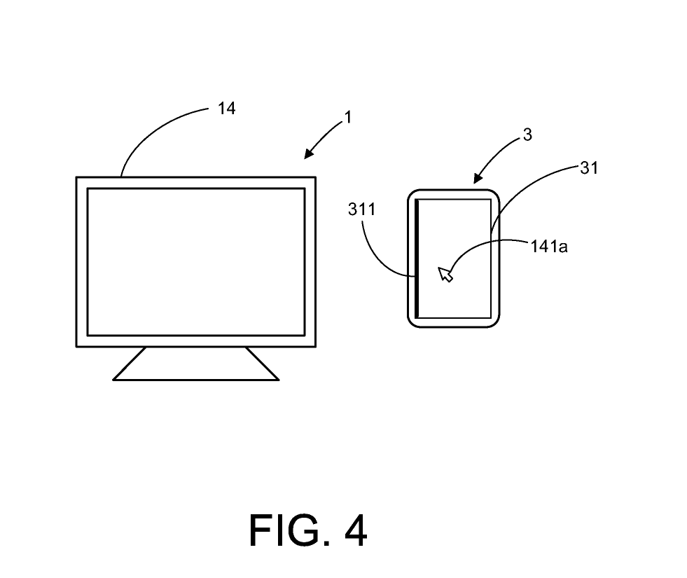

In step S4, the handheld computer 3 monitors an event of the personal computer 3. The step S4 may be performed by the handheld computer 3 calls the Broadcast Receiver function of the ANDROID SDK. The personal computer 1 will inform the handheld computer 3 through the ADK (Accessory Development Kit) once the cursor 141 exceeds one or more edges of the screen of the monitor 14. In step S5, the control right of the mouse 21 is transferred from the personal computer 1 to the handheld computer 3 and the cursor 141 is transferred from the screen of the monitor 14 of the personal computer 1 to the screen of the touchscreen 31 of the handheld computer 3 when the cursor 141 is moved to exceed an edge of the screen of the monitor 1 of the personal computer 1. As shown in FIG. 4, the cursor 141a is shown on the screen of the touchscreen 31 of the handheld computer 3. In other words, the cursor 141a can be used to operate the handheld computer 3. In step S6, the control right of the mouse 21 is transferred from the handheld computer 3 to the personal computer 1 and the cursor 141a is transferred from the screen of the touchscreen 31 of the handheld computer 3 to the screen of the monitor 14 of the personal computer 1 when the cursor 141a is moved to touch the edge bar 311 of the screen of the touchscreen 31 of the handheld computer 3. After that, the cursor 141a will jump to the screen of the monitor of the personal computer 1. In detail, when the cursor 141a touched the edge bar 311, this event will be detected by the View.OnClickListener function, and the handheld computer 3 will inform the personal computer 1 through the Manage mechanism of the ADK.

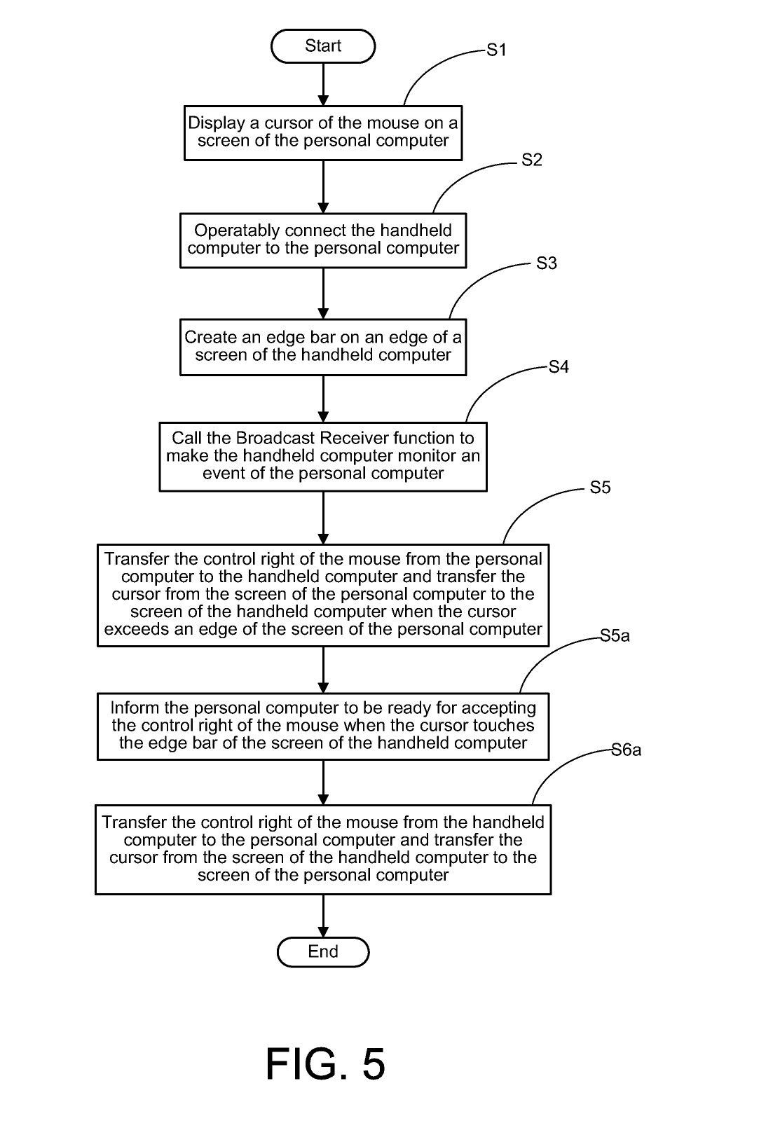

Alternatively, a new step S5a may be added. As shown in FIG. 5, steps S1-S5 are the same as mentioned above and step S6a is substantially the same as step S6. Step S5a is added between step S5 and S6a. In step S5a, the handheld computer 3 informs the personal computer 1 to be ready for accepting the control right of the mouse 21 when the cursor 141a touches the edge bar 311 of the screen of the touchscreen 31 of the handheld computer 3. Finally in step S6a, the control right of the mouse 21 is transferred from the handheld computer 3 to the personal computer 1 and the cursor 141a is transferred from the screen of the touchscreen 31 of the handheld computer 3 to the screen of the monitor 14 of the personal computer 1 after the step S5a. After that, the cursor 141a will jump to the screen of the monitor of the personal computer 1.

It will be appreciated by persons skilled in the art that the above embodiment has been described by way of example only and not in any limitative sense, and that various alterations and modifications are possible without departure from the scope of the invention as defined by the appended claims.

What is claimed is:

1. A method for automatically transferring a control right of a mouse between a handheld computer and a personal computer with the mouse and, comprising the steps of:
a) displaying a cursor of the mouse on a screen of the personal computer;
b) operatably connecting the handheld computer to the personal computer;
c) creating an edge bar on an edge of a screen of the handheld computer;
d) the handheld computer monitoring an event of the personal computer;
e) transferring the control right of the mouse from the personal computer to the handheld computer and transferring the cursor from the screen of the personal computer to the screen of the handheld computer when the cursor exceeds an edge of the screen of the personal computer; and
f) transferring the control right of the mouse from the handheld computer to the personal computer and transferring the cursor from the screen of the handheld computer to the screen of the personal computer when the cursor touches the edge bar of the screen of the handheld computer.

2. The method of claim 1, wherein the personal computer is of a desktop type.

3. The method of claim 1, wherein the personal computer is of a laptop type.

4. The method of claim 1, wherein the handheld computer is a smartphone.

5. The method of claim 1, wherein the handheld computer is a tablet computer.

6. The method of claim 1, wherein the step b) is performed by a USB (universal serial bus) cable.

7. The method of claim 1, wherein the edge bar is on a left or right edge of a screen of the handheld computer.

8. A method for automatically transferring a control right of a mouse between a handheld computer and a personal computer with the mouse and, comprising the steps of:
a) displaying a cursor of the mouse on a screen of the personal computer;
b) operatably connecting the handheld computer to the personal computer;
c) creating an edge bar on an edge of a screen of the handheld computer;
d) the handheld computer monitoring an event of the personal computer;
e) transferring the control right of the mouse from the personal computer to the handheld computer and transferring the cursor from the screen of the personal computer to the screen of the handheld computer when the cursor exceeds an edge of the screen of the personal computer;
f) informing the personal computer to be ready for accepting the control right of the mouse when the cursor touches the edge bar of the screen of the handheld computer; and
g) transferring the control right of the mouse from the handheld computer to the personal computer and transferring the cursor from the screen of the handheld computer to the screen of the personal computer after the step f).

9. The method of claim 8, wherein the personal computer is of a desktop type.

10. The method of claim 8, wherein the personal computer is of a laptop type.

11. The method of claim 8, wherein the handheld computer is a smartphone.

12. The method of claim 8, wherein the handheld computer is a tablet computer.

13. The method of claim 8, wherein the step b) is performed by a USB (universal serial bus) cable.

14. The method of claim 8, wherein the edge bar is on a left or right edge of a screen of the handheld computer.
